(19) United States
(12) Patent Application Publication
(10) Pub. No.: US 2025/0129591 A1
(43) Pub. Date: Apr. 24, 2025

(54) Inlet Guard

(71) Applicants: Kimberly Jewel Bishop, Teague, TX (US); Darren Dwayne Bishop, Teague, TX (US)

(72) Inventors: Kimberly Jewel Bishop, Teague, TX (US); Darren Dwayne Bishop, Teague, TX (US)

(21) Appl. No.: 18/493,305

(22) Filed: Oct. 24, 2023

(51) Int. Cl. E03F 5/06; B01D 29/44; B01D 29/56; B01D 39/10; E01C 11/22

(52) U.S. Cl. CPC E03F 5/06; B01D 29/445; B01D 29/56; B01D 39/10; E01C 11/227

(57) ABSTRACT

A device for an inlet guard is provided. The device includes an inlet having an opening; a screen attached to the opening of the inlet; and a basket attached to the inner side of the inlet, the basket including: a first wire-grid wall located on the rear side of the basket and extending between the left side and the right side of the basket, a second wire-grid wall located on the front side of the basket and extending between the left side and the right side of the basket, and a third wire-grid wall located on the bottom side of the basket and coupled to the first and second wire-grid walls.

### FIELD OF THE INVENTION

The present invention relates generally to an apparatus for an inlet guard. More specifically, the present invention is designed to stop and trap debris and sludge from reaching area waterways and provides added protection for human lives and pets.

### BACKGROUND OF THE INVENTION

Drainage inlets usually lead right into waterways, frequently those that are used by the general public. The present invention is designed to stop and trap debris and sludge from reaching area waterways and provides added protection for human lives and pets.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A device for an inlet guard is provided. According to some embodiments, the device includes an inlet having an opening; a screen made of steel, the screen is attached to the opening of the inlet; and a basket attached to the inner side of the inlet, the basket including:
a first wire-grid wall located on the rear side of the basket and extending between the left side and the right side of the basket, a second wire-grid wall located on the front side of the basket and extending between the left side and the right side of the basket, and a third wire-grid wall located on the bottom side of the basket and coupled to the first and second wire-grid walls,
wherein each of the first, second, and third wire-grid walls comprises: a grid of wire lying in a plane, and a frame extending around the grid of wire.

In one embodiment, the screen is made of ¼ steel round bars and includes a 2″ flatbar that attaches to the inlet by concrete anchors, and a ¼″ round bar, spaced at approximately 3″ intervals.

In another embodiment, the bars are surrounded by 1″ square wire and connected to the inner side of an inlet using washers and concrete anchors.

In some embodiments, the frame is manufactured out of ¼″ steel round bars.

In some other embodiments, the basket is connected to the inner side of the inlet using washers and concrete anchors, the basket is configured to catch any debris that slips past the screen.

### BRIEF DESCRIPTION OF THE DRAWINGS

FIG. 1 is an illustration of one embodiment of the present invention.

FIG. 2 is an illustration of the screen and the basket of the present invention.

FIG. 3 is an illustration of one embodiment of the screen of the present invention.

FIG. 4 is a front view of the screen of the present invention.

FIG. 5 is a side view of the screen of the present invention.

FIG. 6 is a top view of the screen of the present invention.

FIG. 7 is an illustration of one embodiment of the basket of the present invention.

### DETAIL DESCRIPTIONS OF THE INVENTION

All illustrations of the drawings are for the purpose of describing selected versions of the present invention and are not intended to limit the scope of the present invention.

The present invention is designed to stop and trap debris and sludge from reaching area waterways and provides added protection for human lives and pets.

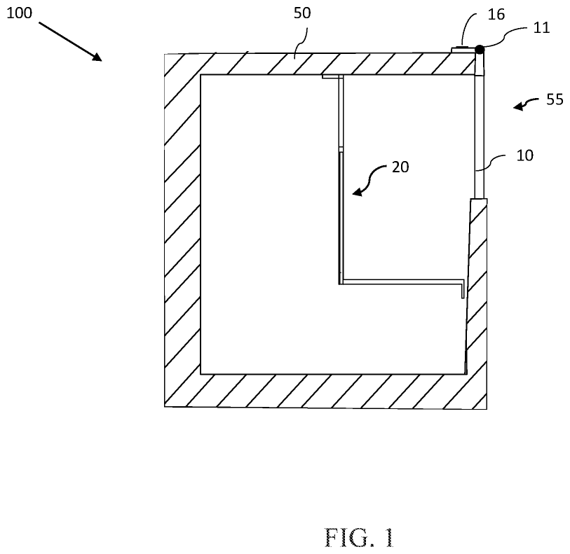

As shown in FIG. 1, the present invention provides a device for the Inlet Guard, the device comprising a screen 10, a bucket 20, and an inlet (storm drain inlet) 50. The inlet 50 may have an opening 55. The inlet (Storm drain inlet) 50 can be made of poured concrete. The inlet (Storm drain inlet) 50 can include an inner space and be in any suitable shape.

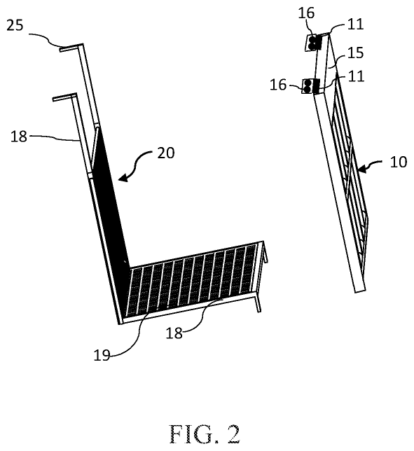

In one embodiment, the screen 10 can be attached to the inlet 50 and the basket 20 can be attached to the inner side of the inlet 50 as shown in FIG. 2. For example, the screen 10 can be attached to the outside of the storm drain inlet 50 or on the opening 55 by brackets (that can be any known brackets) and that can be made of 1″ flat bars and ¼″ round bars. In one embodiment, the brackets can be attached to the top outside of the storm drain inlet 50 with washers and concrete bolts. The ¼″ bar of the brackets can be put through the ½″ tubing 11 that can be attached to the top of the 2″ flat bar 15 so it can be easily clean out of the basket 20.

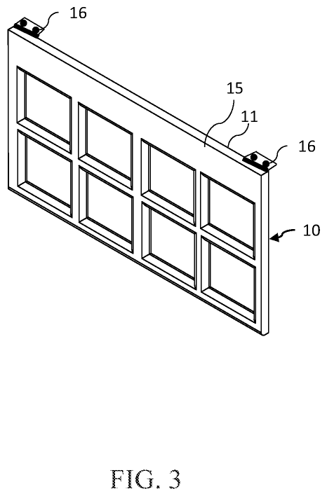

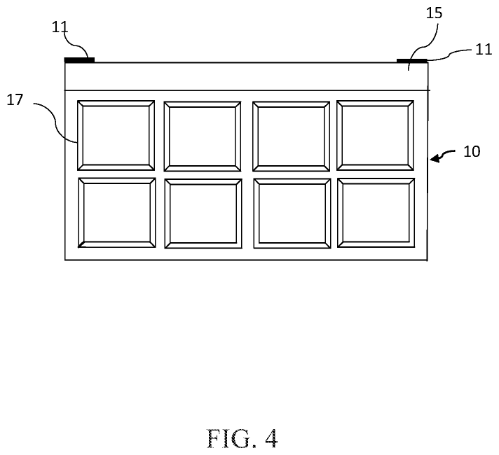

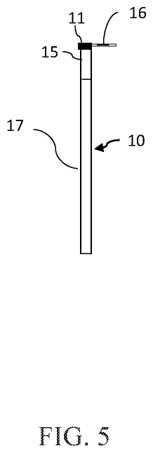

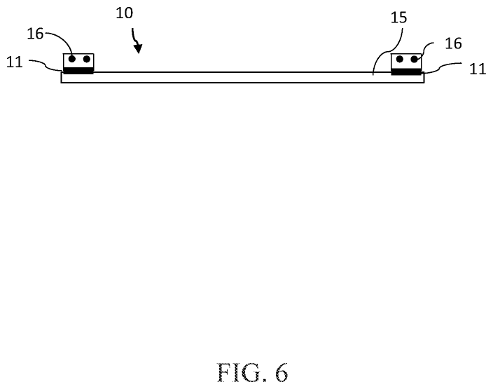

The screen 10, as shown in FIGS. 3-6, can be made from steel and includes one or more flat bars 15, round bars 17 and concrete anchors 16 on the flat bars 15. In some embodiments, the screen 10 may not include any concrete anchors 16. The concrete anchors 16 may include a flat panel or hinge with two or more holes that can be connected to the tubing 11 and can be any other similar fastening mechanism including screws. It should be noted that sizes of the components including flat bars, round bars and tubings can be in any other location with suitable sizes.

Manufactured out of steel; 2″ flatbar (or 1″ flatbar) 15 that attaches to the concrete inlet by concrete anchors 16, and the ¼″ round bar (which can be any other shape, e.g. rectangular bars) 17, spaced at approximately 3″ intervals and measures approximately 3″×3″, this screen 10 is attached on the street side of the inlet. It sits approximately 1″ off of the street, fastened by 1″ spacers in which concrete anchors 16 are housed. Debris that is too large to fit through the screen 10 can be swept up by street sweepers.

In some embodiments, the screen 10 may include one or more tubings 11 that can be the 1″ tubing between the 2″ flat bar 15 and the ¼″ round bar 17 that allows the screen 10 to be opened for easy clean out. The tubing 11 can be an elongated bar or a pipe. The tubing 11 can be attached on top of the screen 10 on the flatbar 15 and the concrete anchors (or a connecting panel or hinge) 16 can be connected to the flatbar 15 by the tubing 16 so that the concrete anchors (or a connecting panel or hinge) 16 can be rotated around the tubing 16. This makes the screen can be rotated open with respect to the concrete anchors (or a connecting panel or hinge) 16.

In some embodiments, the screen 10 may include a plurality of support structures in any suitable shape placed on the bottom of the screen 10.

By having screens 10 on inlet openings, the present invention also provides safety for human lives and pets by preventing accidents such as falling into or getting swept into the inlet opening during a rain or ice storm.

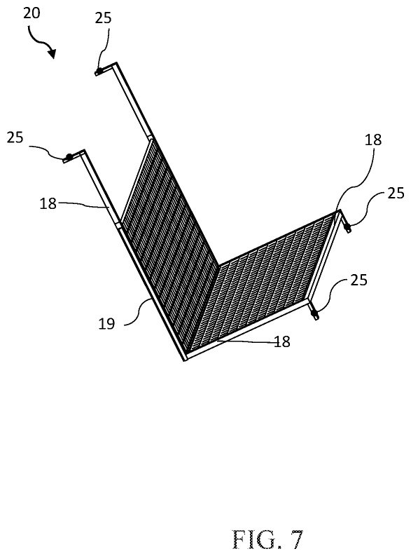

In one embodiment, the basket 20, as shown in FIG. 7, is manufactured out of ¼″ steel round bars 18 that are surrounded by 1″ square wire 19 and connected to the inside of the inlet using washers 25 and concrete anchors 16, the basket 20 may catch any debris that slips past the screen 10. In one embodiment, the basket is ¾″-1″ expanded metal.

The basket 20 is opened at the top to allow for overflow in the event the basket 20 gets full before clean out, and rain water still needs to get by. Debris clean out is performed at regular scheduled times to insure proper working order.

In some embodiments, the present invention may provide a device that comprises an inlet having an opening; a screen made of steel, the screen is attached to the opening of the inlet; and a basket attached to the inner side of the inlet.

The basket may include three wire-grid walls. In such embodiments, the basket may include a first wire-grid wall located on the rear side of the basket and extending between the left side and the right side of the basket, a second wire-grid wall located on the front side of the basket and extending between the left side and the right side of the basket, and a third wire-grid wall located on the bottom side of the basket and coupled to the first and second wire-grid walls, wherein each of the first, second, and third wire-grid walls comprises: a grid of wire lying in a plane, and a frame extending around the grid of wire.

In some optional embodiments, the user can use filters that can be placed inside the basket to retain sludge, oil, grime, etc. that may enter the inlets. By use of filters inside the basket, not only will this product catch trash/debris, it will also stop sludge, oil and grime from entering waterways and endangering fowl and fish. The filters can be any suitable filters known in the art.

Although the invention has been explained in relation to its preferred embodiment, it is to be understood that many other possible modifications and variations can be made without departing from the spirit and scope of the invention.

What is claimed is:

1. A device comprising:
an inlet having an opening;
a screen made of steel, the screen is attached to the opening of the inlet; and
a basket attached to the inner side of the inlet, the basket including:
a first wire-grid wall located on the rear side of the basket and extending between the left side and the right side of the basket,
a second wire-grid wall located on the front side of the basket and extending between the left side and the right side of the basket, and
a third wire-grid wall located on the bottom side of the basket and coupled to the first and second wire-grid walls,
wherein each of the first, second, and third wire-grid walls comprises:
a grid of wire lying in a plane, and
a frame extending around the grid of wire.

2. The device as claimed in claim 1, the screen is made of ¼ steel round bars and includes a 2″ flatbar that attaches to the concrete inlet by concrete anchors, and a ¼″ round bar, spaced at approximately 3″ intervals.

3. The device as claimed in claim 2, the round bars are surrounded by 1″ square wire and connected to the inside of the inlet using washers and concrete anchors.

4. The device as claimed in claim 2, the frame is manufactured out of one or more ¼″ steel round bars.

5. The device as claimed in claim 2, the first, second, and third wire grid walls include at least one 1″ square wire.

6. The device as claimed in claim 2, the basket is connected to the inner of the inlet using washers and concrete anchors, this basket is configured to catch any debris that slips past the screen.

7. The device as claimed in claim 2, the basket includes a filter.

8. A device comprising:
an inlet having an opening;
a screen made of steel, the screen includes a 2″ flatbar that attaches to the inlet by concrete anchors, and a ¼″ round bar, spaced at approximately 3″ intervals, the screen is attached to the outside of the inlet; and
a basket having a filter placed inside of the basket, the basket attached to the inner side of the inlet, the basket including:
a first wire-grid wall located on the rear side of the basket and extending between the left side and the right side of the basket,
a second wire-grid wall located on the front side of the basket and extending between the left side and the right side of the basket, and
a third wire-grid wall located on the bottom side of the basket and coupled to the first and second wire-grid walls,
wherein each of the first, second, and third wire-grid walls comprises:
a grid of wire lying in a plane, and
a frame extending around the grid of wire.

9. The device as claimed in claim 8, the screen is made of ¼ steel round bars.

10. The device as claimed in claim 9, the bars are surrounded by at least one 1″ square wire and connected to the inner of the inlet using washers and concrete anchors.

11. The device as claimed in claim 8, the frame is manufactured out of one or more ¼″ steel round bars.

12. The device as claimed in claim 8, the first, second, and third wire grid walls include at least one 1″ square wire.

13. The device as claimed in claim 8, the basket is connected to the inner side of the inlet using washers and concrete anchors, the basket is configured to catch any debris that slips past the screen.

14. A device comprising:
an inlet having an opening;
a screen that includes a 2″ flatbar that attaches to the inlet by concrete anchors, and a ¼″ round bar, spaced at approximately 3″ intervals, the screen is attached to the outside of the inlet; and
a basket attached to the inner side of the inlet, the basket including:
a first wire-grid wall located on the rear side of the basket and extending between the left side and the right side of the basket,
a second wire-grid wall located on the front side of the basket and extending between the left side and the right side of the basket, and
a third wire-grid wall located on the bottom side of the basket and coupled to the first and second wire-grid walls,
wherein each of the first, second, and third wire-grid walls comprises:
a grid of wire lying in a plane, and
a frame extending around the grid of wire.

15. The device as claimed in claim 14, the screen is made of ¼ steel round bars.

16. The device as claimed in claim 15, the bars are surrounded by at least one 1″ square wire and connected to the inner side of the inlet using washers and concrete anchors.

17. The device as claimed in claim 14, the frame is manufactured out of one ore more ¼″ steel round bars.

18. The device as claimed in claim 14, the first, second, and third wire grid walls include at least one 1″ square wire.

19. The device as claimed in claim 14, the basket is connected to the inner side of the inlet using washers and concrete anchors, the basket is configured to catch any debris that slips past the screen.

20. The device as claimed in claim 14, the basket includes a filter.
